(19) United States
(12) Patent Application Publication
(10) Pub. No.: US 2017/0298860 A1
(43) Pub. Date: Oct. 19, 2017

(54) COOLING STRUCTURE OF MULTI-CYLINDER ENGINE

(71) Applicant: Mazda Motor Corporation, Aki-gun (JP)

(72) Inventors: Uichiro Mori, Hiroshima-shi (JP); Yoshiaki Hayamizu, Higashihiroshima-shi (JP); Daisuke Tabata, Hiroshima-shi (JP); Daisuke Matsumoto, Hiroshima-shi (JP)

(21) Appl. No.: 15/484,710

(22) Filed: Apr. 11, 2017

(30) Foreign Application Priority Data
Apr. 19, 2016 (JP) 2016-083751

(51) Int. Cl. F02F 1/14; F01P 3/02; F01P 5/10

(52) U.S. Cl. CPC F02F 1/14; F01P 5/10; F01P 3/02; F01P 2003/021

(57) ABSTRACT

A cooling structure of a multi-cylinder engine is provided, which includes a first water jacket formed in a cylinder block to surround cylinder bores of cylinders arranged inline, a spacer having a vertical wall surface and inserted into the first jacket, and a coolant inlet formed in the first jacket on a first end side in a cylinder line-up direction. The structure circulates coolant introduced from the inlet to the first jacket and a second water jacket formed in a cylinder head coupled to the cylinder block via a gasket. The spacer has a flow dividing rib extending outwardly from the vertical wall surface and for vertically dividing the coolant flow, introduced from the inlet to an intake- or exhaust-side section of the first jacket, toward the second jacket through a communication hole formed in the gasket and toward a discharging section provided to the cylinder block.

### BACKGROUND

The present invention relates to a cooling structure of a multi-cylinder engine, and particularly to a cooling structure of a multi-cylinder engine which includes a spacer inserted into a water jacket of a cylinder block of the engine.

Generally, vehicles with an engine are formed with water jackets for flowing coolant in the engine cylinder block and cylinder head. The coolant is introduced from the cylinder block at one end in a cylinder line-up direction into the water jacket of the cylinder block, and circulated inside the water jacket of the cylinder block and then into the water jacket of the cylinder head, so as to cool the part of the engine near combustion chambers.

Generally the coolant circulated inside the water jackets of the cylinder block and the cylinder head is discharged to a radiator from the cylinder head at the other end in the cylinder line-up direction, cooled by the radiator, and then introduced into the water jacket of the cylinder block again from the one end of the cylinder block by a water pump.

For example, JP2014-163225A discloses a structure in which a spacer having a vertical wall surface is inserted into a water jacket of a cylinder block to surround cylinder bores. Coolant is introduced from a coolant inlet formed on an end side of a water jacket of the cylinder block in a cylinder line-up direction, circulated in the water jacket of the cylinder block and a water jacket of a cylinder head, and discharged from a cylinder-head-side discharging section formed in the cylinder head on the other end side in the cylinder line-up direction.

The structure of JP2014-163225A flows the coolant introduced into the cylinder block, to an exhaust-side section and an intake-side section of the water jacket of the cylinder block. The coolant flowed to the intake-side section flows from an upper section of the water jacket of the cylinder block to the cylinder head from a center section of the water jacket in the cylinder line-up direction, as well as from a lower section of the water jacket of the cylinder block to a cylinder-block-side discharging section connected to an oil cooler.

With the structure of JP2014-163225A, a flow rate of the coolant discharged from the cylinder-block-side discharging section is controlled by a flow rate control valve connected to the cylinder-block-side discharging section.

Therefore, the coolant flowing in the intake-side section of the water jacket of the cylinder block flows to the cylinder head as well as the cylinder-block-side discharging section when the flow rate control valve is in an open state, whereas it flows to the cylinder head without flowing to the cylinder-block-side discharging section when the flow rate control valve is in a closed state.

Thus, the flow of the coolant introduced from the coolant inlet and flowed to the intake-side section of the water jacket of the cylinder block may greatly change between the open and closed states of the flow rate control valve, and the coolant flow may be disturbed, which may cause a pressure loss of the coolant.

### SUMMARY

The present invention is made in view of the above issues and aims to provide a cooling structure of a multi-cylinder engine, which stably flows coolant introduced from a coolant inlet to a water jacket of a cylinder head and a cylinder-block-side discharging section by preventing disturbance in a flow of the coolant.

According to one aspect of the present invention, a cooling structure of a multi-cylinder engine is provided, which includes a first water jacket formed in a cylinder block to surround cylinder bores of a plurality of cylinders arranged inline, a spacer having a vertical wall surface and inserted into the first water jacket, and a coolant inlet formed in an outer wall of one of an intake-side section and an exhaust-side section of the first water jacket at a position on a first end side in a cylinder line-up direction, and the cooling structure circulating coolant introduced from the coolant inlet to the first water jacket and a second water jacket formed in a cylinder head coupled to the cylinder block via a gasket. The vertical wall surface surrounds the cylinder bores. The coolant inlet causes coolant flows to the intake-side section and the exhaust-side section therefrom, respectively. The cylinder block is formed with a discharging section for discharging the coolant from the first water jacket, in a lower part of the outer wall of the one of the intake-side section and the exhaust-side section of the first water jacket. The gasket is formed with a communication hole communicating the first water jacket with the second water jacket, at a position in the one of the intake-side section and the exhaust-side section of the first water jacket. The spacer has a flow dividing rib extending outwardly from the vertical wall surface to approach the outer wall of the first water jacket, and for vertically dividing the flow of the coolant introduced from the coolant inlet and flowing to the one of the intake-side section and the exhaust-side section of the first water jacket, into a flow toward the second water jacket through the communication hole and a flow toward the discharging section.

Thus, the coolant introduced from the coolant inlet and flowing to the one of the intake- and exhaust-side sections of the first water jacket is vertically divided by the flow dividing rib and stably flows toward the second water jacket and the discharging section.

The path of the coolant after being introduced from the coolant inlet may be switchable between a first path in which the coolant flows to the second water jacket and the discharging section, and a second path in which the coolant flows to the second water jacket and does not flow to the discharging section. In this case, even when the path is switched, a change in the coolant flow on the upper side of the flow dividing rib is prevented, and by preventing disturbance in the coolant flow introduced from the coolant inlet, the coolant stably flows toward the second water jacket and the discharging section.

The flow dividing rib may be spaced apart from the coolant inlet toward a second end side opposite from the first end side in the cylinder line-up direction by a given distance.

According to the above structure, the flow dividing rib is spaced from the coolant inlet toward the second end side by the given distance. Therefore, after the coolant introduced from the coolant inlet flows to the intake- and exhaust-side sections of the first water jacket, the coolant in one of the intake- and exhaust-side sections is divided to flow to the second water jacket side and the discharging section side. Thus, compared to a case where the coolant introduced from the coolant inlet is divided into the flow toward the second water jacket in both of the intake- and exhaust-side sections and the flow toward the discharging section in the one of the intake- and exhaust-side sections, the disturbance in the coolant flow is prevented.

A water pump may be attached to the coolant inlet of the cylinder block. The coolant inlet and the water pump may be provided in a lower section of the first water jacket. The flow dividing rib may incline upwardly while extending from the first end side to the second end side.

According to the above structure, the coolant inlet and the water pump are provided on the lower section of the first water jacket, and the flow dividing rib inclines upwardly while extending from the first end to second end side. Thus, when the water pump is attached to the lower section of the first water jacket while avoiding interference between an intake system and an exhaust system of the engine, the coolant introduced from the coolant inlet stably flows toward the second water jacket along the flow dividing rib.

The coolant inlet may be provided at the first end side of the outer wall of the intake-side section of the first water jacket. The spacer may have a rectifying part extending outwardly from the vertical wall surface to approach the outer wall of the first water jacket and for rectifying the flow of the coolant introduced from the coolant inlet and flowing to the exhaust-side section of the first water jacket. When the spacer is disposed in the first water jacket, the rectifying part may incline continuously upwardly while extending from the first end side to the second end side in the exhaust-side section of the first water jacket, further extending on the second end side from the exhaust-side section to the intake-side section of the first water jacket, and then extending from the second end side to the first end side in the intake-side section of the first water jacket. In the intake-side section of the first water jacket, an end of the rectifying part on the first end side may be coupled to an end of the flow dividing rib on the second end side.

According to the above structure, the spacer includes the rectifying part extending outwardly from the vertical wall surface and for rectifying the flow of the coolant flowing to the exhaust-side section of the first water jacket. The rectifying part inclines continuously upwardly as it extends from the first end to second end side in the exhaust-side section, further extends on the second end side from the exhaust-side section to the intake-side section, and then extends from the second end to first end side in the intake-side section.

Therefore, in the exhaust-side section of the first water jacket, the cross-sectional area of the flow path of the coolant flowing around an outer circumferential side of the vertical wall surface in a single direction from the first end side is gradually reduced. Thus, a degradation in the coolant flow due to a reduced flow rate of the coolant flowing on the outer circumferential side of the vertical wall surface is prevented and coolability of the coolant in upper sections of the cylinder bores is improved.

Further, in the intake-side section of the first water jacket, the end of the rectifying part on the first end side is coupled to the end of the flow dividing rib on the second end side. Therefore the coolant flowing to the exhaust-side section from the first end side flows around the outer circumferential side of the vertical wall surface in the single direction. Thus the coolant stably flows toward the second water jacket from the intake-side section and the cylinder head is effectively cooled.

The spacer may include a protrusion protruding outwardly from a lower part of the vertical wall surface in the intake-side section of the first water jacket, at a position where the vertical wall surface has a maximum dimension in a direction perpendicular to the cylinder line-up direction.

According to the above structure, the spacer includes the protrusion protruding outwardly from the lower part of the vertical wall surface in the intake-side section, at positions where the vertical wall surface has the maximum dimension in the direction perpendicular to the cylinder line-up direction. Therefore, the lower part of the vertical wall surface of the spacer is prevented from contacting the discharging section provided in the intake-side section, while preventing an increase in flow resistance of the coolant, and the flow path in which the coolant introduced from the coolant inlet flows to the discharging section is secured.

### BRIEF DESCRIPTION OF THE DRAWINGS

FIG. 1 is a schematic view illustrating a cooling structure of a multi-cylinder engine according to one embodiment of the present invention.

FIG. 2 is a view illustrating a cylinder block, a spacer, and a gasket of the multi-cylinder engine according to this embodiment.

FIG. 3 is a perspective view illustrating the cylinder block into which the spacer is inserted.

FIG. 4 is a cross-sectional view of the cylinder block taken along a line Y4-Y4 of FIG. 3.

FIG. 5 is a cross-sectional view of the cylinder block taken along a line Y5-Y5 of FIG. 4.

FIG. 6 is a cross-sectional view of the cylinder block taken along a line Y6-Y6 of FIG. 4.

FIG. 7 is a cross-sectional view of the cylinder block taken along a line Y7-Y7 of FIG. 4.

FIG. 8 is a cross-sectional view of the cylinder block taken along a line Y8-Y8 of FIG. 4.

FIG. 9 is a perspective view illustrating the spacer.

FIG. 10 is a perspective view illustrating the spacer seen in an A-direction of FIG. 9.

FIG. 11 is a front view of the spacer.

FIG. 12 is a rear view of the spacer.

FIG. 13 is a left-side view of the spacer.

FIG. 14 is a right-side view of the spacer.

FIG. 15 is a view illustrating a substantial part of the spacer.

FIG. 16 is a view illustrating another substantial part of the spacer.

FIG. 17 is a view illustrating a flow of coolant when a flow rate control valve connected to a cylinder-block-side discharging section is in a closed state.

### DETAILED DESCRIPTION OF EMBODIMENT

Hereinafter, one embodiment of the present invention is described with reference to the accompanying drawings.

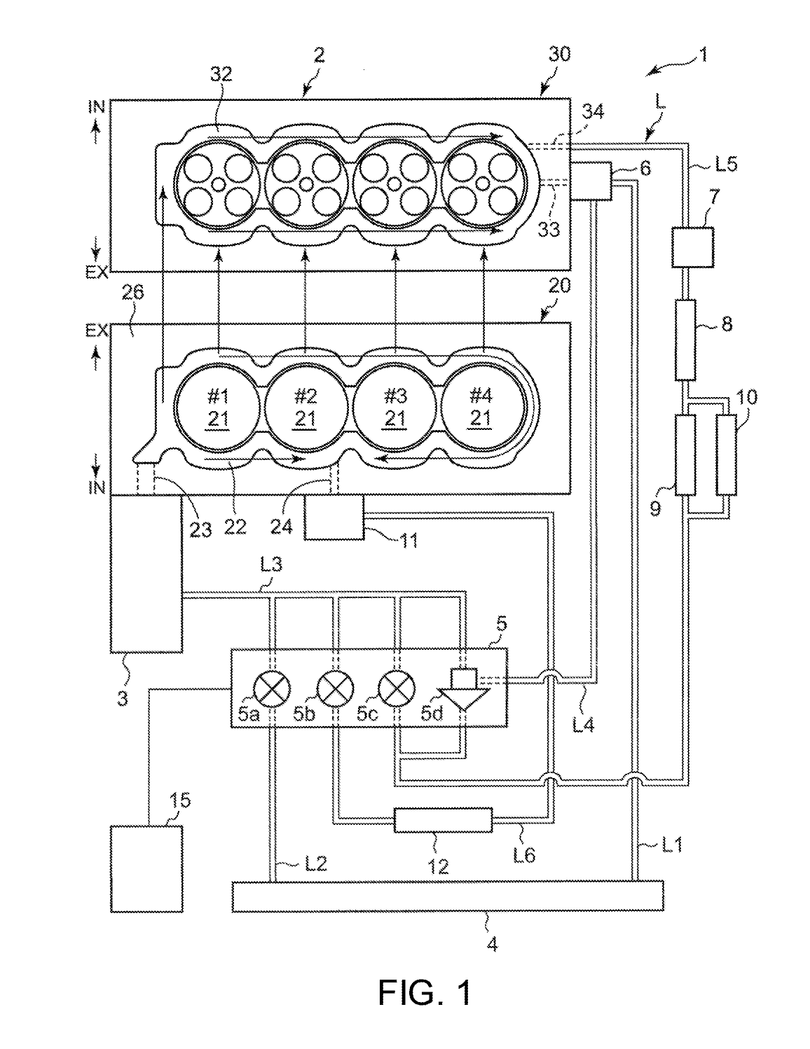

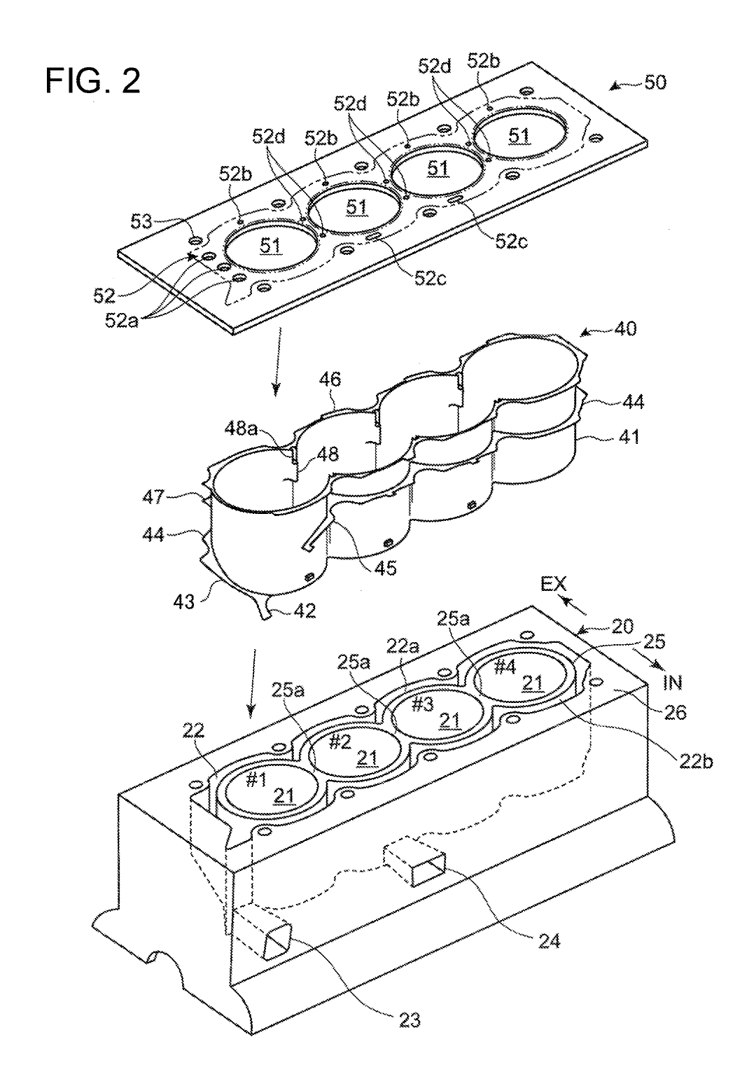

FIG. 1 is a schematic view illustrating a cooling structure 1 of a multi-cylinder engine 2 according to this embodiment. Note that in FIG. 1 as well as FIGS. 2 to 8, an intake side of a cylinder block and a cylinder head is denoted as “IN,” and an exhaust side of the cylinder block and the cylinder head is denoted as “EX.”

As illustrated in FIG. 1, the cooling structure 1 of the multi-cylinder engine of this embodiment includes a coolant path L extending through a water jacket 22 formed in a cylinder block 20 to surround cylinder bores 21 of a plurality of cylinders #1, #2, #3 and #4 arranged inline in this order, and a water jacket 32 formed in a cylinder head 30 coupled to the cylinder block 20. In the coolant path L, coolant is circulated by a water pump 3 through the water jacket 22 of the cylinder block 20, the water jacket 32 of the cylinder head 30, and a radiator 4 for cooling the coolant.

The engine 2 is a multi-cylinder engine, specifically an inline four-cylinder engine provided with the four arranged inline cylinders #1 to #4, and the cylinder block 20 is formed with the water jacket 22 extending annularly to surround the cylinder bores 21 of the four cylinders #1 to #4.

In the cylinder block 20, a coolant inlet 23 for introducing the coolant to the water jacket 22 of the cylinder block 20 is formed on the first end side, specifically on the first cylinder #1 side (hereinafter, may be referred to as “the first end side”). The coolant inlet 23 is formed in an outer wall 26 of the water jacket 22 at a position on the intake side and the first end side, to extend from the intake to exhaust side. The water pump 3 is attached to the coolant inlet 23 of the cylinder block 20.

Further in the cylinder block 20, a cylinder-block-side discharging section 24 for discharging the coolant from the water jacket 22 is formed on the intake side, at a lower position of a center part of the outer wall 26 in the cylinder line-up direction. An oil cooler 11 is attached to the cylinder-block-side discharging section 24 of the cylinder block 20.

The cylinder block 20 and the cylinder head 30 are coupled to each other, sandwiching therebetween a gasket 50 which is illustrated in FIG. 2 (described later). The water jacket 22 of the cylinder block 20 communicates with the water jacket 32 of the cylinder head 30 through communication holes 52 formed in the gasket 50.

Therefore, the coolant introduced into the first end side of the water jacket 22 of the cylinder block 20 flows to the water jacket 32 of the cylinder head 30 through the communication holes 52, as well as it circulates in the water jacket 22 of the cylinder block 20 and is discharged from the center part through the cylinder-block-side discharging section 24.

The water jacket 32 of the cylinder head 30 is formed over the entire cylinder line-up from the first end side to the other end side (second end side), specifically to the fourth cylinder #4 side, to cover intake ports, exhaust ports, plug ports (not illustrated), etc. of the cylinders #1 to #4.

The cylinder head 30 is formed with first and second cylinder-head-side discharging sections 33 and 34 for discharging the coolant from the water jacket 32 to the second end side. The coolant introduced from the water jacket 22 of the cylinder block 20 to the water jacket 32 of the cylinder head 30 circulates in the water jacket 32 and is discharged from the second end side through the first and second cylinder-head-side discharging sections 33 and 34.

The coolant discharged from the first cylinder-head-side discharging section 33 flows to the radiator 4 through a temperature detecting unit 6 provided with a temperature detecting sensor (not illustrated) for detecting a temperature of the coolant, and a coolant path L1 connecting the first cylinder-head-side discharging section 33 with the radiator 4. The coolant is cooled by the radiator 4 and then flows to a valve unit 5 through a coolant path L2 connecting the radiator 4 with the valve unit 5.

The valve unit 5 includes a first flow rate control valve 5a, a second flow rate control valve 5b, a third flow rate control valve 5c and a thermostatic valve 5d. The first to third flow rate control valves 5a to 5c are controlled in open and close operations, and flow rates by a control device 15. The thermostatic valve 5d becomes an open state when the temperature of the coolant at the thermostatic valve 5d reaches a given temperature.

The coolant flowed to the valve unit 5 through the coolant path L2 flows to the water pump 3 through the first flow rate control valve 5a and a coolant path L3 connecting the valve unit 5 with the water pump 3. Then the water pump 3 introduces the coolant into the water jacket 22 of the cylinder block 20.

The coolant discharged from the first cylinder-head-side discharging section 33 also flows to the valve unit 5 through the temperature detecting unit 6 and a coolant path L4 connecting the first cylinder-head-side discharging section 33 with the valve unit 5. The coolant path L4 is connected with the coolant path L3 via the thermostatic valve 5d, and the coolant discharged from the first cylinder-head-side discharging section 33 flows to the water pump 3 through the temperature detecting unit 6, the coolant path L4, the thermostat valve 5d, and the coolant path L3. Then the water pump 3 introduces the coolant into the water jacket 22 of the cylinder block 20.

The coolant discharged from the second cylinder-head-side discharging section 34, on the other hand, flows to the valve unit 5 through a coolant path L5 connecting the second cylinder-head-side discharging section 34 with the valve unit 5. An auxiliary water pump 7 for supplementarily pumping the coolant, a heater unit 8 for exchanging heat between the coolant and air conditioning wind, an exhaust gas recirculation (EGR) cooler 9 for exchanging heat between the coolant and exhaust gas recirculated to the intake side, and an EGR valve 10 for controlling a supply amount of the coolant to the EGR cooler 9 are provided on the coolant path L5. The EGR cooler 9 and the EGR valve 10 constitute an EGR system for recirculating part of the exhaust gas to the intake side.

The coolant flowed to the valve unit 5 through the coolant path L5 flows to the water pump 3 through the third flow rate control valve 5c and the coolant path L3. Then the water pump 3 introduces the coolant into the water jacket 22 of the cylinder block 20.

The coolant which flows to the valve unit 5 through the coolant path L5 also flows through the thermostatic valve 5d. When the temperature of the coolant is the given temperature or above and the thermostatic valve 5d is in the open state, the coolant flows to the water pump 3 through the thermostatic valve 5d and the coolant path L3.

Moreover, the coolant discharged from the cylinder-block-side discharging section 24 formed in the cylinder block 20 flows to the valve unit 5 through a coolant path L6 connecting the cylinder-block-side discharging section 24 with the valve unit 5. The oil cooler 11 for exchanging heat between the coolant and engine oil, and an automatic transmission fluid (ATF) warmer 12 for exchanging heat between the coolant and ATF, which is an oil for automatic transmissions, are provided on the coolant path L6.

The coolant flowed to the valve unit 5 through the coolant path L6 flows to the water pump 3 through the second flow rate control valve 5b and the coolant path L3. Then the water pump 3 introduces the coolant into the water jacket 22 of the cylinder block 20.

Thus, the cooling structure 1 of the multi-cylinder engine of this embodiment circulates the coolant introduced from the coolant inlet 23 formed in the outer wall 26 of the water jacket 22 of the cylinder block 20, to the water jacket 22 and the water jacket 32 of the cylinder head 30.

The control device 15 includes a processor and receives signals from a fuel injection amount sensor (not illustrated) for detecting a fuel injection amount, an engine speed sensor (not illustrated) for detecting an engine speed, the temperature detecting sensor for detecting the temperature of the coolant, etc. Further, the control device 15 determines a load state of the engine 2 based on the fuel injection amount and the engine speed. Then, the control device 15 estimates wall surface temperatures of combustion chambers of the engine 2 based on the detected coolant temperature and the determined load state of the engine 2. The control device 15 controls the flow rate control valves 5a, 5b and 5c according to the estimated wall surface temperatures of the combustion chambers of the engine 2.

The control device 15 controls all the first to third flow rate control valves 5a to 5c to close in a cold start of the engine 2, which corresponds to a state where the wall surface temperatures of the combustion chambers are below a first temperature (e.g., 150 degrees). The control device 15 controls the third flow rate control valve 5c to open when the wall surface temperatures become the first temperature or above. The control device 15 controls the second flow rate control valve 5b to open in addition to the third flow rate control valve 5c when the wall surface temperatures become a second temperature (higher than the first temperature) or above. The control device 15 controls the first flow rate control valve 5a to open in addition to the second and third flow rate control valves 5b and 5c when the wall surface temperatures become a third temperature (higher than the second temperature) or above.

When the estimated wall surface temperatures of the combustion chambers of the engine 2 are below the second temperature, the coolant introduced from the coolant inlet 23 into the water jacket 22 of the cylinder block 20, without being discharged through the cylinder-block-side discharging section 24, flows to the water jacket 32 of the cylinder head 30 through the communication holes 52 and is discharged from the cylinder-head-side discharging sections 33 and 34. On the other hand, when the estimated wall surface temperatures of the combustion chambers of the engine 2 are the second temperature or above, the coolant is discharged through the cylinder-block-side discharging section 24 as well as it flows to the water jacket 32 of the cylinder head 30 through the communication holes 52 and is discharged from the cylinder-head-side discharging sections 33 and 34.

FIG. 2 is a view illustrating the cylinder block, a spacer, and the gasket of the multi-cylinder engine of this embodiment. As illustrated in FIG. 2, in the engine 2 of this embodiment, a spacer 40 having a vertical wall surface 41 is inserted into the water jacket 22 of the cylinder block 20, to surround the cylinder bores 21 of the four cylinders #1 to #4.

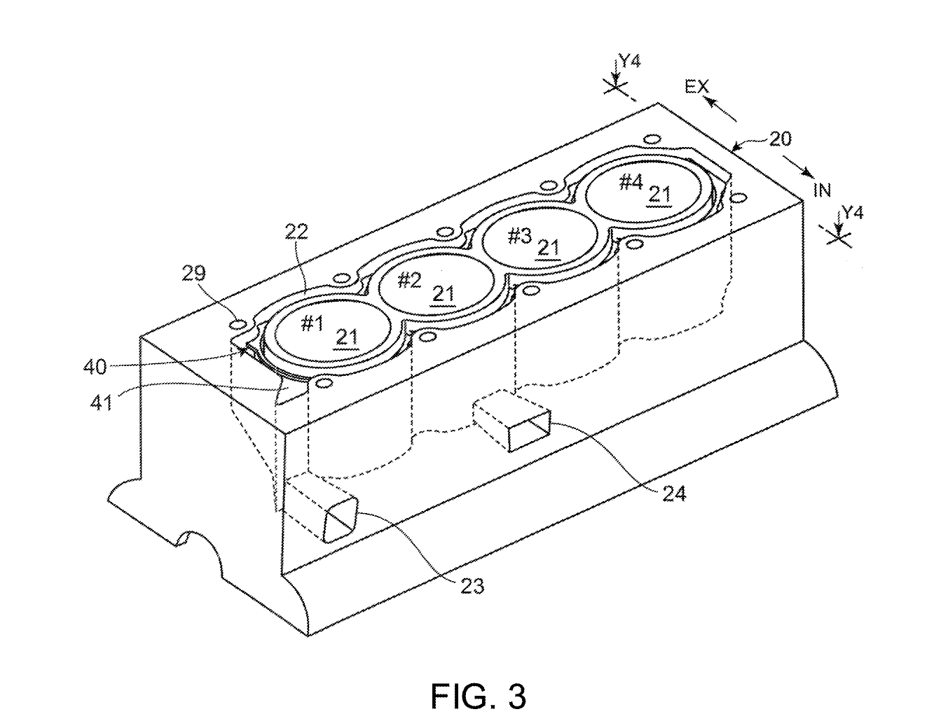

In the state where the spacer 40 is inserted into the water jacket 22, the gasket 50 is placed on the cylinder block 20 and the cylinder block 20 is coupled to the cylinder head 30 by fastening bolts (not illustrated) via the gasket 50. An outer circumferential part of the gasket 50 is formed with bolt through-holes 53 through which the fastening bolts are inserted, and an outer circumferential part of the cylinder block 20 is formed with bolt bores 29 (see FIG. 3) into which the fastening bolts are inserted.

The gasket 50 is also formed with four openings 51, each formed in a circle similarly to the cylinder bore 21, and the communication holes 52 communicating the water jacket 22 of the cylinder block 20 with the water jacket 32 of the cylinder head 30 and for allowing the coolant to flow therethrough. Note that in FIG. 2, the two-dotted chain line on the gasket 50 indicates the shape of the water jacket 22 of the cylinder block 20.

The communication holes 52 formed in the gasket 50 include, for example, three communication holes 52a disposed on the first end side where the coolant inlet 23 is formed, four communication holes 52b disposed on the exhaust side of the openings 51 formed corresponding to the four cylinders #1 to #4, two communication holes 52c disposed on the intake side of the openings 51 formed corresponding to two of the center-side cylinders (#2 and #3 in this embodiment), and six communication holes 52d disposed at the intake side and the exhaust side of inter-cylinder-bore portions 25a of the cylinder block 20.

The cooling structure of the multi-cylinder engine of this embodiment is described more into detail with reference to FIGS. 3 to 17.

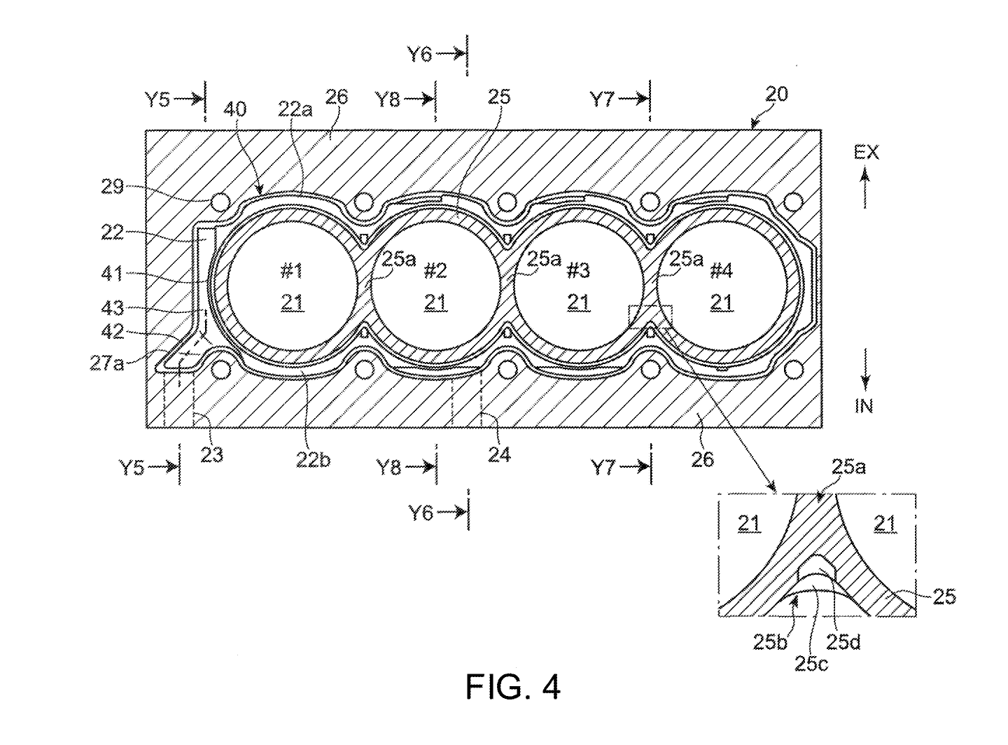

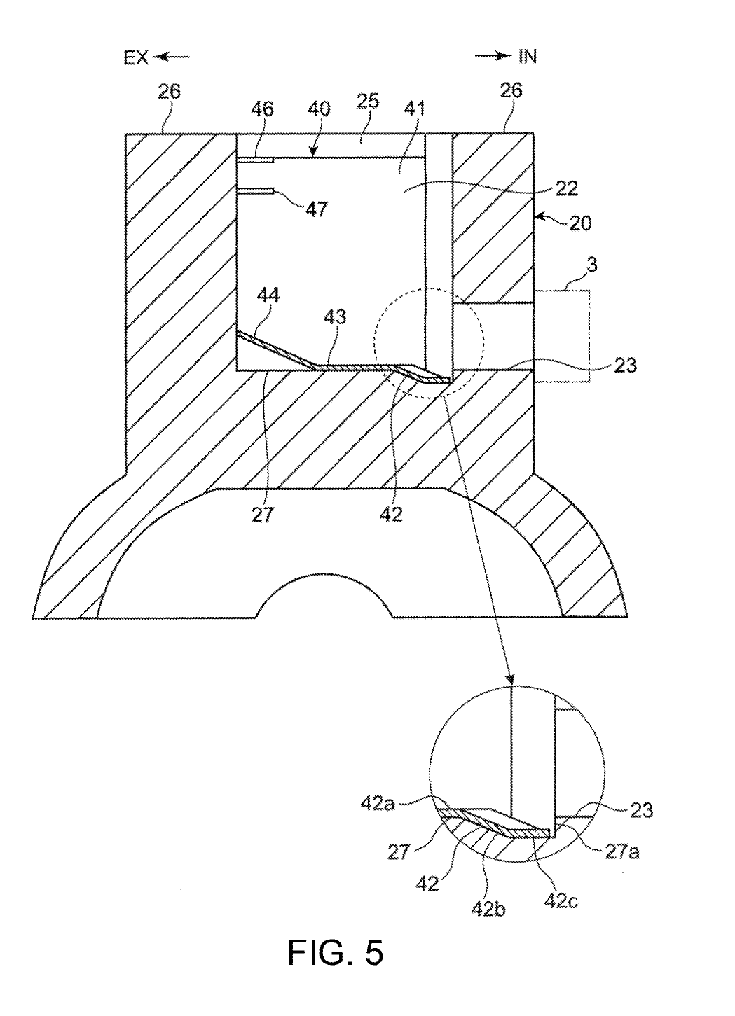

FIG. 3 is a perspective view illustrating the cylinder block inserted therein with the spacer. FIG. 4 is a cross-sectional view of the cylinder block taken along a line Y4-Y4 of FIG. 3. FIGS. 5 to 8 are cross-sectional views of the cylinder block taken along lines Y5-Y5, Y6-Y6, Y7-Y7 and Y8-Y8 of FIG. 4, respectively.

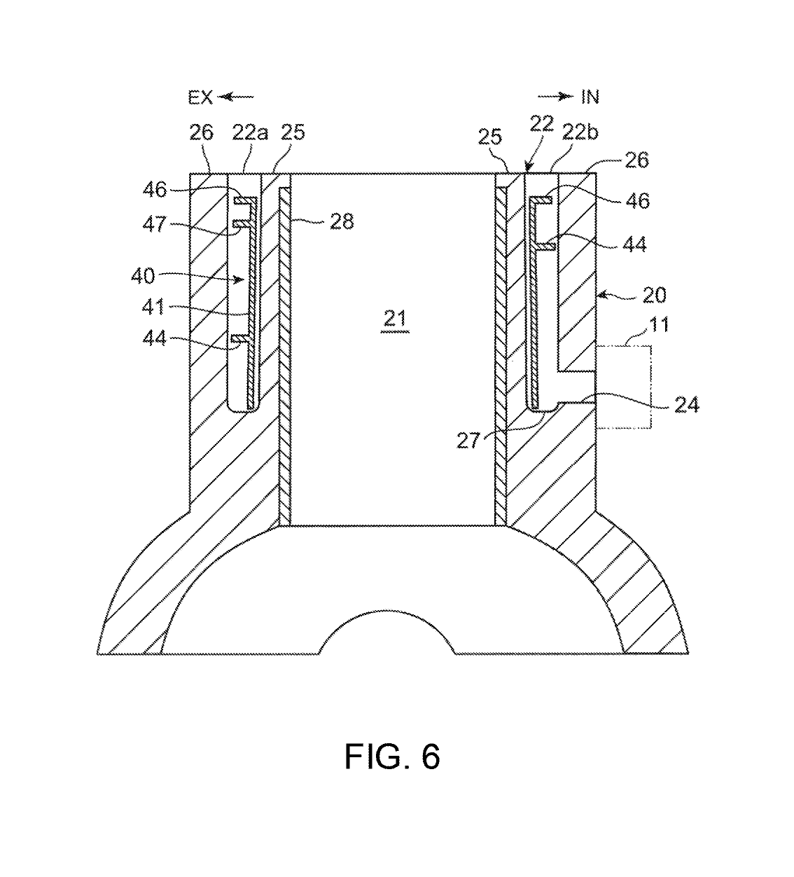

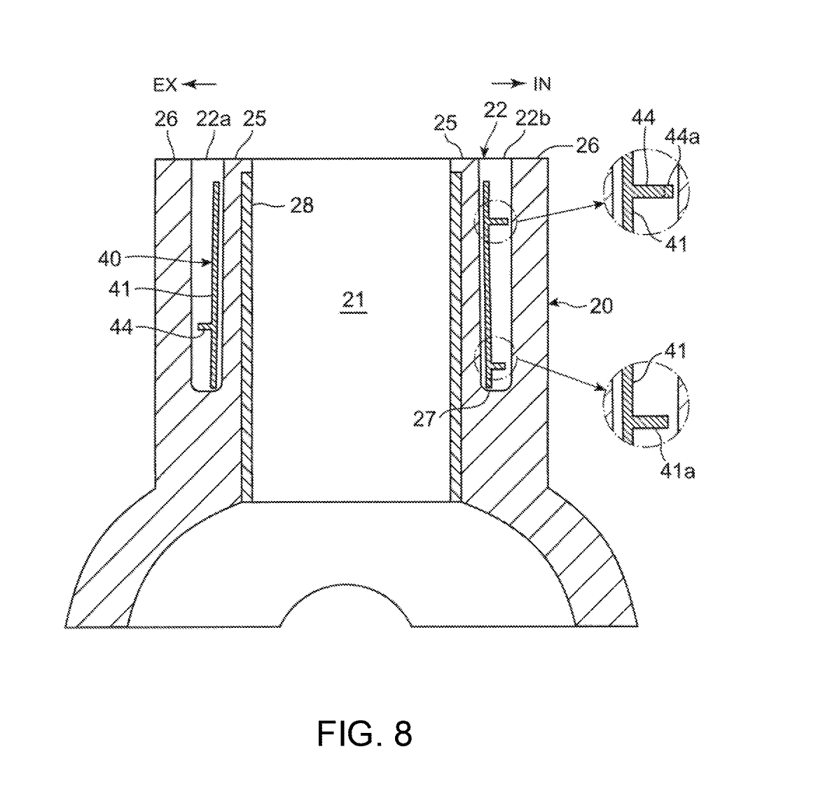

As illustrated in FIGS. 3 to 8, the spacer 40 inserted into the water jacket 22 of the cylinder block 20 includes the vertical wall surface 41 to surround the cylinder bores 21 of the four cylinders #1 to #4, and is disposed between an inner wall 25 of the water jacket 22 of the cylinder block 20 and the outer wall 26 of the water jacket 22 of the cylinder block 20. Note that as illustrated in FIGS. 6 and 8, the inner wall 25 of the water jacket 22 of the cylinder block 20 is integrally formed with a liner 28 having wearing resistance.

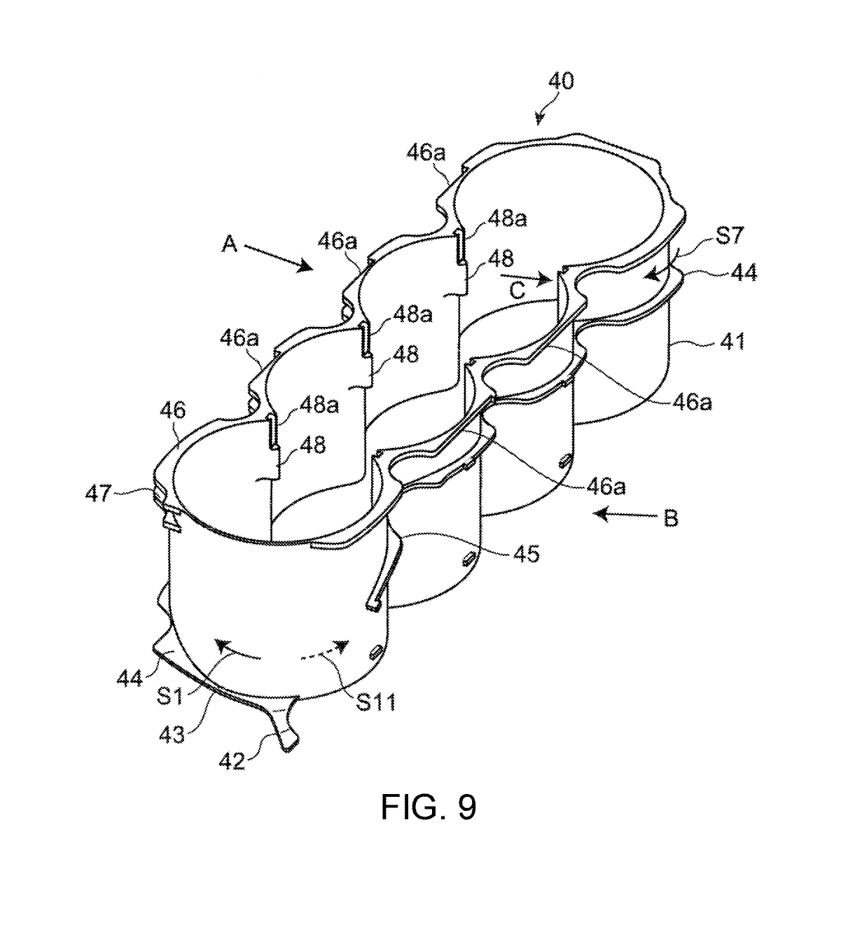

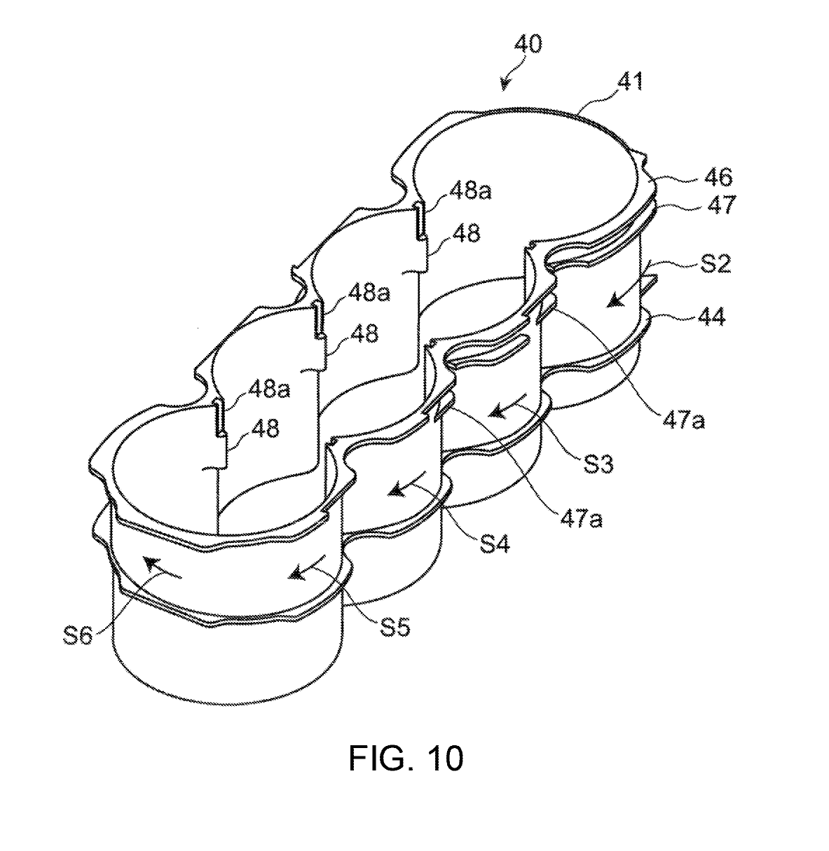

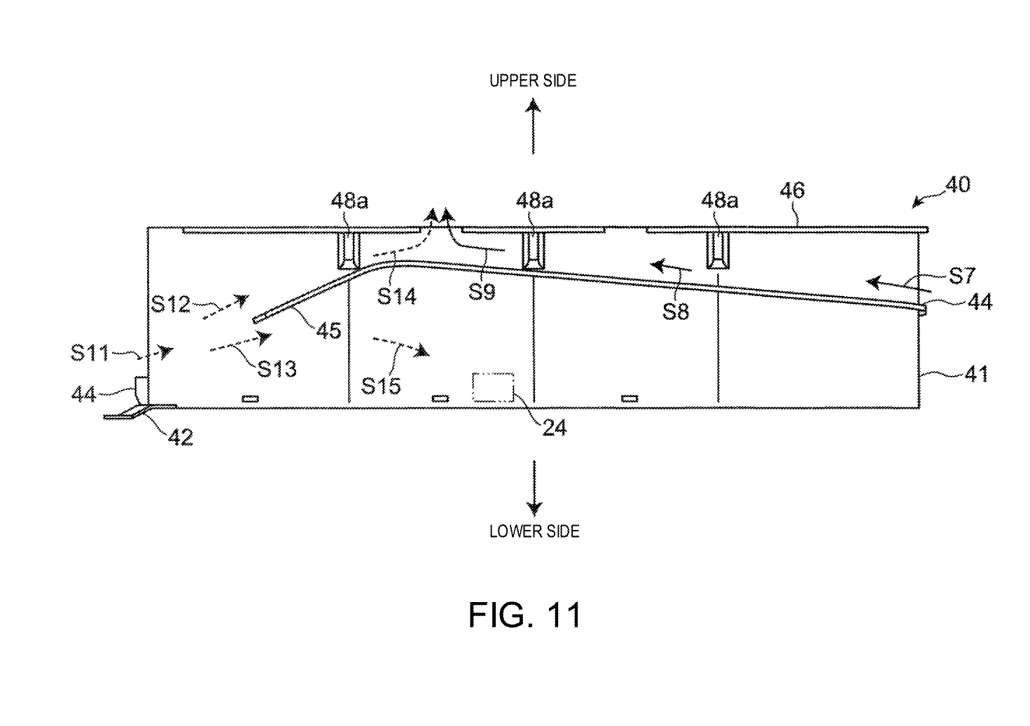

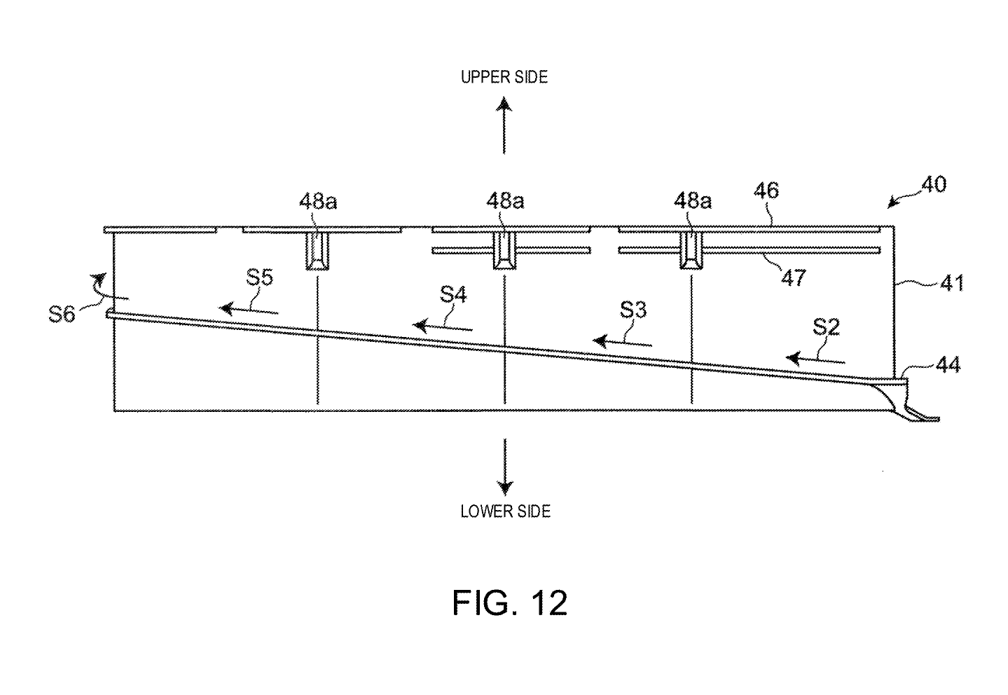

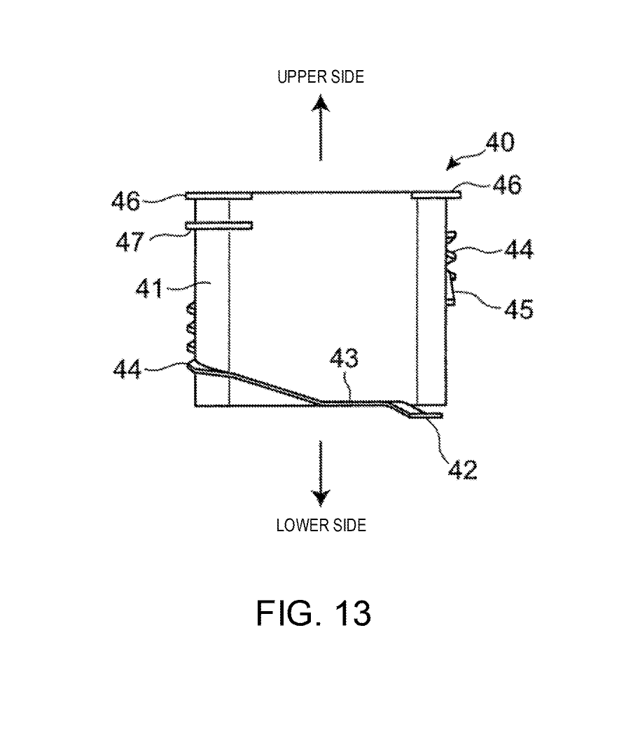

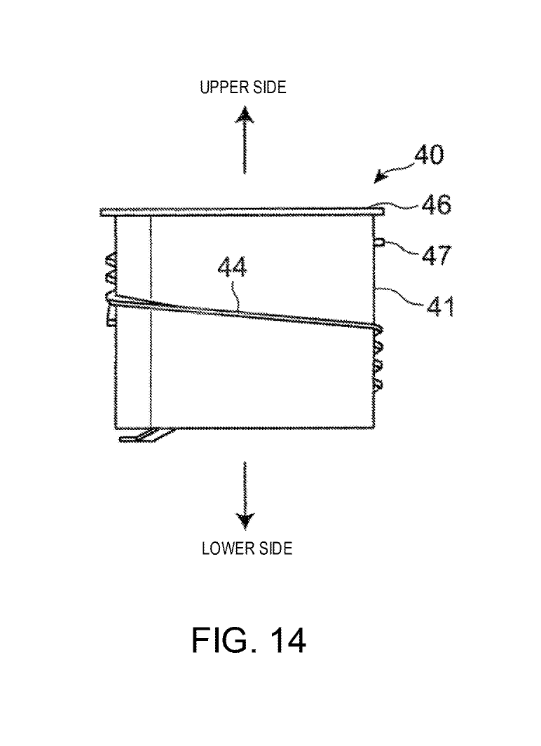

FIG. 9 is a perspective view illustrating the spacer. FIG. 10 is a perspective view illustrating the spacer seen in an A-direction of FIG. 9. FIG. 11 is a front view of the spacer. FIG. 12 is a rear view of the spacer. FIG. 13 is a left-side view of the spacer. FIG. 14 is a right-side view of the spacer.

As illustrated in FIGS. 9 to 14, the vertical wall surface 41 of the spacer 40 is formed annularly to surround the cylinder bores 21 of the four cylinders #1 to #4 and to vertically extend. A lower end part of the vertical wall surface 41 is provided with a guide part 42 at a position on the intake side and the first end side, at a position corresponding to the coolant inlet 23 of the cylinder block 20. The guide part 42 guides the coolant introduced from the coolant inlet 23 to flow around the vertical wall surface 41.

The guide part 42 is formed by a rib protruding outwardly from the vertical wall surface 41. As illustrated in FIG. 5, the guide part 42 extends obliquely outwardly from the lower end part of the vertical wall surface 41 along a bottom wall 27 of the water jacket 22 of the cylinder block 20, toward the coolant inlet 23 which is located at the position on the intake side and the first end side.

As described above, the water pump 3 is attached to the coolant inlet 23 formed in the outer wall 26, and the coolant inlet 23 and the water pump 3 are provided at the vertically same position (same height) as the bottom wall 27.

The bottom wall 27 is formed with a concaved section 27a denting downward than the coolant inlet 23. The guide part 42 of the spacer 40 extends from the lower end part of the vertical wall surface 41 into the concaved section 27a formed in the bottom wall 27.

The guide part 42 includes an upper surface portion 42a extending substantially horizontally from the vertical wall surface 41 to the coolant inlet 23 side, an inclining portion 42b inclining downwardly while extending from the upper surface portion 42a to the coolant inlet 23 side, and a lower surface portion 42c extending substantially horizontally from the inclining portion 42b to the coolant inlet 23 side. Portions of the inclining portion 42b and the lower surface portion 42c on the coolant inlet 23 side are positioned in the concaved section 27a. The concaved section 27a formed in the bottom wall 27 is formed along the guide part 42 according to the shape of the guide part 42.

The coolant introduced from the coolant inlet 23 is guided to flow around the vertical wall surface 41 by the guide part 42 which is provided in the lower end part of the vertical wall surface 41 to extend along the bottom wall 27 of the water jacket 22 toward the coolant inlet 23. Therefore, a coolant flow into a section between the vertical wall surface 41 of the spacer 40 and the inner wall 25 of the water jacket 22 of the cylinder block 20 from the lower side of the spacer 40 is reduced.

In this embodiment, the guide part 42 extends obliquely to the intake side and the first end side from the lower end part of the vertical wall surface 41. The coolant introduced from the coolant inlet 23 is guided so that a major part thereof flows to an exhaust-side section 22a of the water jacket 22 and a part flows to an intake-side section 22b of the water jacket 22.

The vertical wall surface 41 is also provided with a flange part 43 substantially horizontally extending outwardly from the vertical wall surface 41, adjacently to the guide part 42 at the first end side of the lower end part of the vertical wall surface 41. The flange part 43 is formed corresponding to the shape of the outer wall 26 of the water jacket 22 so as to approach the outer wall 26 of the water jacket 22 of the cylinder block 20. The flange part 43 and the guide part 42 are formed continuously with each other in the lower end part of the vertical wall surface 41. Therefore, a coolant flow into the section between the vertical wall surface 41 of the spacer 40 and the inner wall 25 of the water jacket 22 of the cylinder block 20 from the lower side of the spacer 40 is more effectively reduced.

The spacer 40 also includes a rectifying part 44 extending outwardly from the vertical wall surface 41 adjacently to the flange part 43 provided to the lower end part of the vertical wall surface 41, so as to approach the outer wall 26 of the water jacket 22 of the cylinder block 20. The rectifying part 44 rectifies the flow of the coolant introduced from the coolant inlet 23.

When the spacer 40 is disposed in the water jacket 22 of the cylinder block 20, the rectifying part 44 inclines continuously upwardly at a fixed inclination as it extends from the first end to second end side in the exhaust-side section 22a of the water jacket 22, further extends on the second end side from the exhaust-side section 22a to the intake-side section 22b of the water jacket 22, and then extends from the second end to first end side in the intake-side section 22b of the water jacket 22.

The rectifying part 44 rectifies the flow of the coolant flowing to the exhaust-side section 22a of the water jacket 22 from the first end side, so that the coolant flows around the outer circumferential side of the vertical wall surface 41 of the spacer 40 in a single direction, and further flows to an upper section of the water jacket 22 of the cylinder block 20. The rectifying part 44 and the flange part 43 are formed continuously with each other in the vertical wall surface 41.

The spacer 40 also has the plurality of openings 48a (e.g., six in this embodiment), at positions of an upper part of the vertical wall surface 41 corresponding to the inter-cylinder-bore portions 25a of the cylinder block 20, on the upper side of the rectifying part 44.

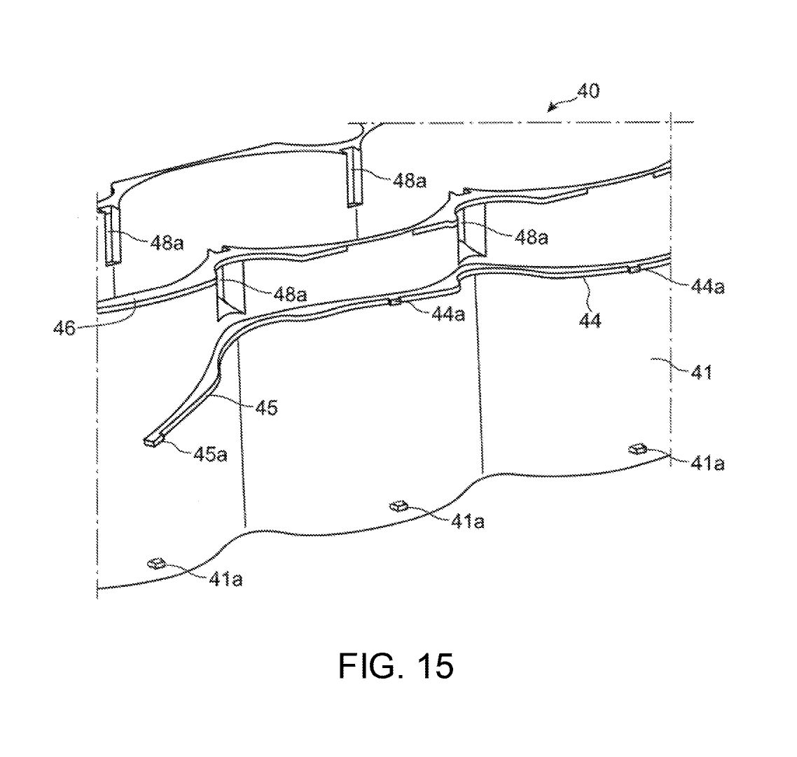

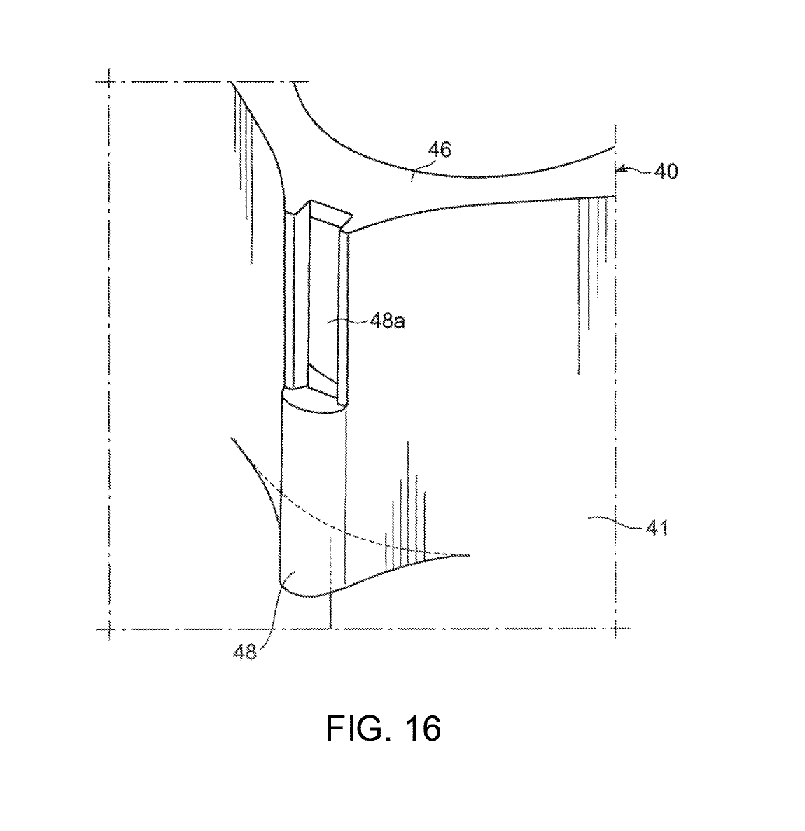

FIG. 15 is a view illustrating a substantial part of the spacer seen in a B-direction of FIG. 9. FIG. 16 is a view illustrating a different substantial part of the spacer seen in a C-direction of FIG. 9.

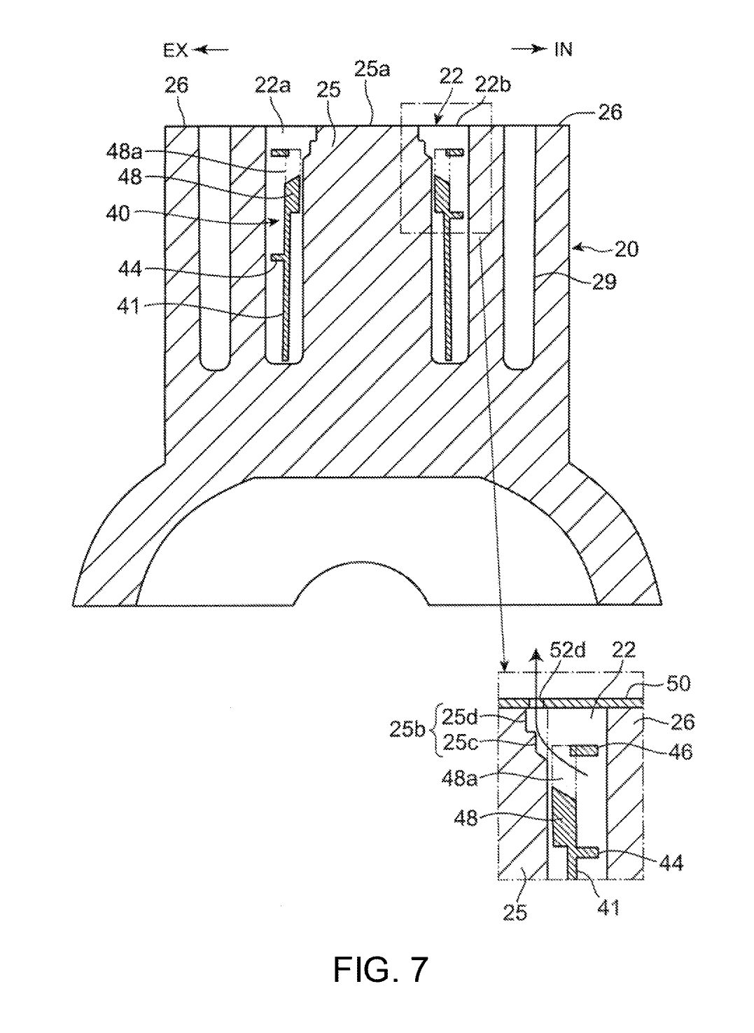

As illustrated in FIGS. 7, 15 and 16, the openings 48a formed in the vertical wall surface 41 open to the intake side and the exhaust side of the inter-cylinder-bore portions 25a of the cylinder block 20. Therefore, the coolant flowing on the outer circumferential side of the vertical wall surface 41 of the spacer 40 flows to the inner circumferential side thereof through the openings 48a.

The enlarged view of the cylinder block 20 of FIG. 7 also illustrates the gasket 50. The coolant flowed to the inner circumferential side of the vertical wall surface 41 through the openings 48a flows to the water jacket 32 of the cylinder head 30 through the communication holes 52d of the gasket 50. Therefore, upper sections of the cylinder bores 21 are cooled compared to lower sections thereof, and upper parts of the inter-cylinder-bore portions 25a of the cylinder block 20 are cooled.

In the vertical wall surface 41, protruding portions 48 protruding inwardly to approach the inner wall 25 of the water jacket 22 are also formed on the lower side of the openings 48a. Each protruding portion 48 is provided in the upper part of the vertical wall surface 41 to have a given vertical length. Thus, while a weight increase of the spacer 40 is avoided, a downward flow of the coolant on the inner circumferential side of the vertical wall surface 41 through the openings 48a is reduced, and the upper sections of the cylinder bores 21 are effectively cooled.

As illustrated in FIGS. 4 and 7, upper end portions of the inter-cylinder-bore portions 25a of the cylinder block 20 are formed with concaved sections 25b at the intake and exhaust sides, to dent inwardly in directions perpendicular to the cylinder line-up direction and the vertical directions (hereinafter, these perpendicular directions are referred to as extending “laterally”). The openings 48a of the vertical wall surface 41 are provided in the upper end part of the vertical wall surface 41 corresponding to the concaved sections 25b formed in the inter-cylinder-bore portions 25a of the cylinder block 20.

For example, each of the concaved sections 25b formed in the inter-cylinder-bore portions 25a of the cylinder block 20 is comprised of a first concaved section 25c and a second concaved section 25d. The first concaved section 25c laterally dents inwardly, from one of the intake- and exhaust-side sections. The second concaved section 25d dents further inward of the first concaved section 25c. Thus, the coolant flowing to the inner circumferential side of the vertical wall surface 41 through the openings 48a is oriented to flow to the concaved sections 25b formed in the inter-cylinder-bore portions 25a, and the inter-cylinder-bore portions 25a of the cylinder block 20 are effectively cooled.

The spacer 40 also includes a flange part 46 extending outwardly from the upper end part of the vertical wall surface 41 at positions corresponding to the exhaust-side section 22a, the second end side, and the intake-side section 22b of the water jacket 22, so as to approach the outer wall 26 of the water jacket 22 of the cylinder block 20. The flange part 46 is formed on the upper side of the openings 48a and extends in the cylinder line-up direction, over the openings 48a formed in the vertical wall surface 41.

As illustrated in FIG. 9, the flange part 46 is formed with cutout sections 46a by being cut in parts on the outer circumferential side to promote the flow of the coolant from the water jacket 22 of the cylinder block 20 to the cylinder head 30 through the communication holes 52 of the gasket 50. The cutout sections 46a are formed corresponding to the communication holes 52b disposed on the exhaust side of the second to fourth cylinders #2 to #4 and the communication holes 52c disposed on the intake side of the second and third cylinders #2 and #3.

The spacer 40 also includes a flange part 47 in the vertical wall surface 41 corresponding to the exhaust-side section 22a of the water jacket 22. The flange part 47 extends outwardly on the lower side of the flange part 46 formed in the upper end part of the vertical wall surface 41, to approach the outer wall 26 of the water jacket 22 of the cylinder block 20. The flange part 47 extends over the openings 48a formed in the vertical wall surface 41 in the cylinder line-up direction, provided at the same height as the openings 48a, and formed with parts corresponding to the openings 48a cut out.

As illustrated in FIG. 12, the flange part 47 is provided to extend substantially horizontally from both ends of two of the openings 48a in the cylinder line-up direction, the two of the openings 48a corresponding to the inter-cylinder-bore portion 25a between the first and second cylinders #1 and #2 and the inter-cylinder-bore portion 25a between the second and third cylinders #2 and #3, respectively.

As illustrated in FIG. 10, the flange part 47 is also formed with cutout sections 47a by being cut in parts on the outer circumferential side to promote the flow of the coolant flowing from the water jacket 22 of the cylinder block 20 to the cylinder head 30 through the communication holes 52 of the gasket 50. The cutout sections 47a are formed corresponding to the communication holes 52b disposed on the exhaust side of the second and third cylinders #2 and #3.

The spacer 40 includes the flange part 46 extending outwardly from the upper end part of the vertical wall surface 41, and the flange part 47 extending outwardly on the lower side of the flange part 46. Since the flange part 47 is provided at the same height as the openings 48a and cut out in parts corresponding to the openings 48a, the coolant flow into the section between the vertical wall surface 41 of the spacer 40 and the inner wall 25 of the water jacket 22 of the cylinder block 20 from the outer circumferential side of the vertical wall surface 41 through the upper side of the spacer 40 is reduced.

In this embodiment, the spacer 40 includes a flow dividing rib 45 in the vertical wall surface 41 corresponding to the intake-side section 22b of the water jacket 22. The flow dividing rib 45 extends outwardly from the vertical wall surface 41 to approach the outer wall 26 of the water jacket 22 of the cylinder block 20. The flow dividing rib 45 vertically divides the flow of the coolant introduced from the coolant inlet 23 and flowing to the intake-side section 22b of the water jacket 22, into a flow toward the water jacket 32 of the cylinder head 30 through the communication holes 52 (specifically, the communication holes 52c disposed on the intake side of the second and third cylinders #2 and #3) and a flow toward the cylinder-block-side discharging section 24.

As illustrated in FIG. 11, the flow dividing rib 45 is spaced from the coolant inlet 23 (specifically, from the guide part 42 provided corresponding to the coolant inlet 23) to the second end side by a given distance. The flow dividing rib 45 inclines upwardly continuously at a fixed inclination as it extends from the first end to second end side.

The flow dividing rib 45 extends on the lower side of the openings 48a, to the second end side from a center part of the vertical wall surface 41 in the vertical directions, at a position where the part of the vertical wall surface 41 corresponding to the first cylinder #1 takes a maximum lateral dimension. The rectifying part 44 in the intake-side section 22b of the water jacket 22 and the flow dividing rib 45 in the cylinder line-up direction, in the intake-side section 22b of the water jacket 22.

As illustrated in FIG. 15, the spacer 40 also includes protrusions 41a protruding outwardly at the intake-side section 22b side of the lower part of the vertical wall surface 41, at positions where the parts of the vertical wall surface 41 surrounding the cylinder bores 21 of the first to third cylinders #1 to #3 take maximum lateral dimensions, respectively. The protrusions 41a are provided corresponding to the cylinder-block-side discharging section 24.

In the spacer 40, as illustrated in FIGS. 8 and 15, the rectifying part 44 and the flow dividing rib 45 provided at the intake-side section 22b side of the upper part of the vertical wall surface 41 are also formed with protrusions 44a and a protrusion 45a, respectively. The protrusions 44a protrude outwardly at positions where the parts of the vertical wall surface 41 surrounding the cylinder bores 21 of the second and third cylinders #2 and #3 take maximum lateral dimensions, respectively. The protrusion 45a protrudes outwardly at a position where the part of the vertical wall surface 41 surrounding the cylinder bore 21 of the first cylinder #1 takes a maximum lateral dimension. The protrusions 44a and 45a are also provided corresponding to the cylinder-block-side discharging section 24.

Note that, the spacer 40 is integrally formed by injection molding using a material, such as polyamide-based thermoplastic resin.

Next the flow of the coolant introduced into the water jacket 22 of the cylinder block 20 inserted therein the spacer 40 is described.

As indicated by the arrow S1 of FIG. 9, the coolant introduced into the first end side of the cylinder block 20 mainly flows to the exhaust-side section 22a of the water jacket 22. The coolant flows to the upper part of the exhaust-side section 22a of the water jacket 22 by the rectifying part 44.

As illustrated in FIG. 10, by the rectifying part 44, the coolant flowed to the exhaust-side section 22a of the water jacket 22 flows upwardly while flowing to the second end side in the exhaust-side section 22a of the water jacket 22 in the order of the arrows S2, S3, S4 and S5. The coolant flowed to the second end side flows to the intake-side section 22b of the water jacket 22 at the arrow S6 and flows upwardly.

As illustrated in FIGS. 9 and 11, by the rectifying part 44, the coolant flowed to the second end side of the intake-side section 22b of the water jacket 22 flows upwardly while flowing to the first end side in the intake-side section 22b of the water jacket 22 in the order of the arrows S7, S8 and S9. Then the coolant flows to the water jacket 32 of the cylinder head 30 through the communication holes 52c.

After the coolant is introduced from the first end side and flowed to the exhaust-side section 22a of the water jacket 22, when the coolant flows around the outer circumferential side of the vertical wall surface 41 of the spacer 40 in the single direction, it also flows to the inner circumferential side of the vertical wall surface 41 of the spacer 40 through the openings 48a formed in the upper part of the vertical wall surface 41 of the spacer 40, to cool the upper sections of the cylinder bores 21 and the inter-cylinder-bore portions 25a. The coolant flowed to the inner circumferential side of the vertical wall surface 41 of the spacer 40 flows to the water jacket 32 of the cylinder head 30 through the communication holes 52d.

After the coolant is introduced from the first end side and flowed to the exhaust-side section 22a of the water jacket 22, when the coolant flows around the outer circumferential side of the vertical wall surface 41 of the spacer 40 in the single direction, it partially flows to the water jacket 32 of the cylinder head 30 through the communication holes 52a, 52b and 52c.

On the other hand, as indicated by the arrow S11 of FIG. 9, the coolant introduced into the first end side of the cylinder block 20, partially flows to the intake-side section 22b of the water jacket 22. When the flow rate control valve 5b connected with the cylinder-block-side discharging section 24 is in an open state, as illustrated in FIG. 11, the flow of this coolant is vertically divided by the flow dividing rib 45, into the flow on the upper side of the flow dividing rib 45 indicated by the arrow S12 and the flow on the lower side of the flow dividing rib 45 indicated by the arrow S13.

The coolant flowing on the upper side of the flow dividing rib 45 flows upwardly while flowing to the second end side in the intake-side section 22b of the water jacket 22 and, as indicated by the arrow S14, flows to the water jacket 32 of the cylinder head 30 through the communication holes 52c. The coolant flowing on the upper side of the flow dividing rib 45 partially flows to the inner circumferential side of the vertical wall surface 41 of the spacer 40 through the openings 48a formed in the upper part of the vertical wall surface 41, and cools the upper sections of the cylinder bores 21 and the inter-cylinder-bore portions 25a. The coolant flowed to the inner circumferential side of the vertical wall surface 41 flows to the water jacket 32 of the cylinder head 30 through the communication holes 52d.

On the other hand, the coolant flowing on the lower side of the flow dividing rib 45 flows to the second end side in the intake-side section 22b of the water jacket 22, and as indicated by the arrow S15, flows to the cylinder-block-side discharging section 24.

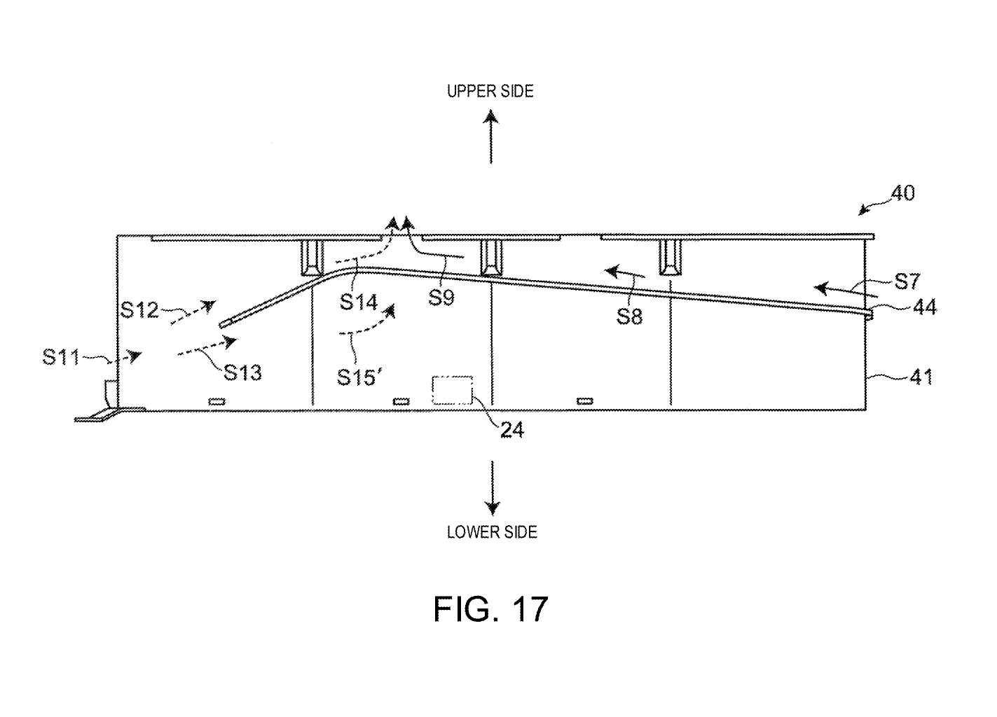

FIG. 17 is a view illustrating a flow of the coolant in a closed state of the flow rate control valve connected to the cylinder-block-side discharging section. As illustrated in FIG. 17, also when the flow rate control valve 5b is in the closed state, the coolant introduced from the first end side and flowed to the intake-side section 22b of the water jacket 22 is vertically divided, into the flow on the upper side of the flow dividing rib 45 indicated by the arrow S12 and the flow on the lower side of the flow dividing rib 45 indicated by the arrow S13.

Similar to when the flow rate control valve 5b is in the open state, the coolant flowing on the upper side of the flow dividing rib 45 flows upwardly while flowing to the second end side in the intake-side section 22b of the water jacket 22 and, as indicated by the arrow S14, flows to the water jacket 32 of the cylinder head 30 through the communication holes 52c. A part of the coolant flowing on the upper side of the flow dividing rib 45 flows to the inner circumferential side of the vertical wall surface 41 of the spacer 40 through the openings 48a formed in the upper part of the vertical wall surface 41 of the spacer 40.

On the other hand, although the coolant flowing on the lower side of the flow dividing rib 45 flows to the second end side in the intake-side section 22b of the water jacket 22, it does not flow to the cylinder-block-side discharging section 24 and, as indicated by the arrow S15′, flows toward the water jacket 32 of the cylinder head 30.

In this embodiment, the coolant inlet 23 is formed at the first end side of the outer wall 26 of the intake-side section 22b of the water jacket 22 of the cylinder block 20; however, in the outer wall 26 of the intake-side portion 22b, the coolant inlet may be formed at the first end side in the exhaust-side portion 22a of the water jacket 22 of the cylinder block 20, and the cylinder-block-side discharging section may be formed in the center part in the exhaust-side portion 22a.

In such a case, the guide part provided to the vertical wall surface 41 of the spacer 40, similar to the guide part 42, is provided at a position on the exhaust side and the first end side corresponding to the coolant inlet. The guide part guides the coolant introduced from the coolant inlet to mainly flow to the intake-side section 22b of the water jacket 22, and partially flow to the exhaust-side section 22a of the water jacket 22.

The rectifying part provided to the vertical wall surface 41 of the spacer 40, similar to the rectifying part 44, inclines continuously upwardly as it extends from the first end to second end side in the intake-side section 22b of the water jacket 22, further extends on the second end side from the intake-side section 22b to the exhaust-side section 22a of the water jacket 22, and then extends from the second end to first end side in the exhaust-side section 22a of the water jacket 22.

The flow dividing rib provided to the vertical wall surface 41 of the spacer 40, similar to the flow dividing rib 45, vertically divides the flow of the coolant introduced from the coolant inlet and flowing in the exhaust-side section 22a of the water jacket 22, into the flow toward the water jacket 32 of the cylinder head 30 and the flow toward the cylinder-block-side discharging section 24.

As described above, with the cooling structure 1 of the multi-cylinder engine according to this embodiment, the spacer 40 inserted into the water jacket 22 of the cylinder block 20 includes the flow dividing rib 45 extending outwardly from the vertical wall surface 41 and for vertically dividing the flow of the coolant introduced from the coolant inlet 23 formed on the first end side, and flowing to one of the exhaust- and intake-side sections 22a and 22b of the water jacket 22, into the flow toward the water jacket 32 of the cylinder head 30 through the communication holes 52c formed in the gasket 50 and the flow toward the cylinder-block-side discharging section 24 formed in the cylinder block 20.

Thus, the coolant introduced from the coolant inlet 23 and flowing to the one of the exhaust- and intake-side sections 22a and 22b of the water jacket 22 is vertically divided by the flow dividing rib 45 and stably flows toward the water jacket 32 of the cylinder head 30 and the cylinder-block-side discharging section 24.

The path of the coolant after being introduced from the coolant inlet 23 may be switchable between the first path in which the coolant flows to the water jacket 32 of the cylinder head 30 and the cylinder-block-side discharging section 24 and the second path in which the coolant flows to the water jacket 32 of the cylinder head 30 and does not flow to the cylinder-block-side discharging section 24. In this case, even when the path is switched, a change in the coolant flow on the upper side of the flow dividing rib 45 is prevented, and by preventing disturbance in the coolant flow introduced from the coolant inlet 23, the coolant stably flows toward the water jacket 32 of the cylinder head 30 and the cylinder-block-side discharging section 24.

Further, the flow dividing rib 45 is spaced from the coolant inlet 23 toward the second end side by the given distance. Therefore, after the coolant introduced from the coolant inlet 23 flows to the exhaust- and intake-side sections 22a and 22b of the water jacket 22, the coolant in one of the exhaust- and intake-side sections 22a and 22b of the water jacket 22 is divided to flow to the water jacket 32 side of the cylinder head 30 and the cylinder-block-side discharging section 24 side. Thus, compared to a case where the coolant introduced from the coolant inlet 23 is divided into the flow toward the water jacket 32 in both of the exhaust- and intake-side sections 22a and 22b and the flow toward the cylinder-block-side discharging section 24 in the one of the exhaust- and intake-side sections 22a and 22b, the disturbance in the coolant flow is prevented.

The coolant inlet 23 and the water pump 3 are provided on a lower section of the water jacket 22, and the flow dividing rib 45 inclines upwardly as it extends from the first end to second end side. Thus, when the water pump 3 is attached to the lower section of the water jacket 22, while avoiding interference between an intake system and an exhaust system of the engine 2, the coolant introduced from the coolant inlet 23 stably flows toward the water jacket 32 along the flow dividing rib 45.

The spacer 40 includes the rectifying part 44 extending outwardly from the vertical wall surface 41 and for rectifying the flow of the coolant flowing to the exhaust-side section 22a of the water jacket 22. The rectifying part 44 inclines continuously upwardly as it extends from the first end to second end side in the exhaust-side section 22a, further extends on the second end side from the exhaust-side section 22a to the intake-side section 22b, and then extends from the second end to first end side in the intake-side section 22b of the water jacket 22.

Therefore, in the exhaust-side section 22a of the water jacket 22, the cross-sectional area of the flow path of the coolant flowing around the outer circumferential side of the vertical wall surface 41 in the single direction from the first end side is gradually reduced. Therefore, the degradation in the coolant flow due to a reduced flow rate of the coolant flowing on the outer circumferential side of the vertical wall surface 41 is prevented and coolability of the coolant in the upper sections of the cylinder bores 21 is improved.

In the intake-side section 22b of the water jacket 22, the end of the rectifying part 44 on the first end side is coupled to the end of the flow dividing rib 45 on the second end side. Therefore the coolant flowing to the exhaust-side section 22a from the first end side flows around the outer circumferential side of the vertical wall surface 41 in the single direction. Thus the coolant stably flows toward the water jacket 32 from the intake-side section 22b and the cylinder head 30 is effectively cooled.

The spacer 40 includes the protrusions 41a protruding outwardly from the lower part of the vertical wall surface 41 in the intake-side section 22b, at positions where the vertical wall surface 41 laterally has maximum dimensions, respectively. Therefore, the lower part of the vertical wall surface 41 of the spacer 40 is prevented from contacting the cylinder-block-side discharging section 24 provided in the intake-side section 22b while preventing an increase in flow resistance of the coolant, and the flow path in which the coolant introduced from the coolant inlet 23 flows to the cylinder-block-side discharging section 24 is secured.

The present invention is not limited to the illustrated embodiment, and various improvements and modifications in design may be made without deviating from the scope of the present invention.

As described above, according to the present invention, in multi-cylinder engines, a coolant stably flows toward a water jacket of a cylinder head and a cylinder-block-side discharging section by preventing disturbance in a flow of the coolant. Therefore, it is possible to suitably use the present invention in the technical fields of manufacturing vehicles on which multi-cylinder engines are installed.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

2 Engine
20 Cylinder Block
21 Cylinder Bore
22 Water Jacket of Cylinder Block (First Water Jacket)
23 Coolant Inlet
24 Cylinder-block-side Discharging Section (Discharging Section)
25 Inner Wall of Water Jacket
26 Outer Wall of Water Jacket
30 Cylinder Head
32 Water Jacket of Cylinder Head (Second Water Jacket)
40 Spacer
41 Vertical Wall Surface
41a, 44a, 45a Protrusion
43, 46, 47 Flange Part
44 Rectifying Part
45 Flow Dividing Rib
#1, #2, #3, #4 Cylinder

What is claimed is:

1. A cooling structure of a multi-cylinder engine, comprising:
a first water jacket formed in a cylinder block to surround cylinder bores of a plurality of cylinders arranged inline,
a spacer having a vertical wall surface and inserted into the first water jacket, and
a coolant inlet formed in an outer wall of one of an intake-side section and an exhaust-side section of the first water jacket at a position on a first end side in a cylinder line-up direction, the cooling structure circulating coolant introduced from the coolant inlet to the first water jacket and a second water jacket formed in a cylinder head coupled to the cylinder block via a gasket, wherein
the vertical wall surface surrounds the cylinder bores,
the coolant inlet causes coolant flows to the intake-side section and the exhaust-side section therefrom, respectively,
the cylinder block is formed with a discharging section for discharging the coolant from the first water jacket, in a lower part of the outer wall of the one of the intake-side section and the exhaust-side section of the first water jacket,
the gasket is formed with a communication hole communicating the first water jacket with the second water jacket, at a position in the one of the intake-side section and the exhaust-side section of the first water jacket, and
the spacer has a flow dividing rib extending outwardly from the vertical wall surface to approach the outer wall of the first water jacket, and for vertically dividing the flow of the coolant introduced from the coolant inlet and flowing to the one of the intake-side section and the exhaust-side section of the first water jacket, into a flow toward the second water jacket through the communication hole and a flow toward the discharging section.

2. The cooling structure of claim 1, wherein the flow dividing rib is spaced apart from the coolant inlet toward a second end side opposite from the first end side in the cylinder line-up direction by a given distance.

3. The cooling structure of claim 1, wherein:
a water pump is attached to the coolant inlet of the cylinder block,
the coolant inlet and the water pump are provided in a lower section of the first water jacket, and
the flow dividing rib inclines upwardly while extending from the first end side to the second end side.

4. The cooling structure of claim 1, wherein:
the coolant inlet is provided at the first end side of the outer wall of the intake-side section of the first water jacket,
the spacer has a rectifying part extending outwardly from the vertical wall surface to approach the outer wall of the first water jacket and for rectifying the flow of the coolant introduced from the coolant inlet and flowing to the exhaust-side section of the first water jacket,
when the spacer is disposed in the first water jacket, the rectifying part inclines continuously upwardly while extending from the first end side to the second end side in the exhaust-side section of the first water jacket, further extending on the second end side from the exhaust-side section to the intake-side section of the first water jacket, and then extending from the second end side to the first end side in the intake-side section of the first water jacket, and
in the intake-side section of the first water jacket, an end of the rectifying part on the first end side is coupled to an end of the flow dividing rib on the second end side.

5. The cooling structure of claim 4, wherein the spacer includes a protrusion protruding outwardly from a lower part of the vertical wall surface in the intake-side section of the first water jacket, at a position where the vertical wall surface has a maximum dimension in a direction perpendicular to the cylinder line-up direction.
